(19) United States
(12) Patent Application Publication
(10) Pub. No.: US 2017/0200258 A1
(43) Pub. Date: Jul. 13, 2017

(54) SUPER-RESOLUTION IMAGE RECONSTRUCTION METHOD AND APPARATUS BASED ON CLASSIFIED DICTIONARY DATABASE

(71) Applicant: PEKING UNIVERSITY SHENZHEN GRADUATE SCHOOL, Shenzhen (CN)

(72) Inventors: Yang ZHAO, Shenzhen (CN); Ronggang WANG, Shenzhen (CN); Zhenyu WANG, Shenzhen (CN); Wen GAO, Shenzhen (CN); Wenmin WANG, Shenzhen (CN); Shengfu DONG, Shenzhen (CN); Tiejun HUANG, Shenzhen (CN); Siwei MA, Shenzhen (CN)

(73) Assignee: PEKING UNIVERSITY SHENZHEN GRADUATE SCHOOL, Shenzhen (CN)

(21) Appl. No.: 15/314,091

(22) PCT Filed: May 28, 2014
(86) PCT No.: PCT/CN2014/078614

§ 371 Date: Nov. 27, 2016

(51) Int. Cl. G06T 3/40; G06T 5/50

(52) U.S. Cl. CPC G06T 3/4053; G06T 5/50; G06T 2207/20081

(57) ABSTRACT

A super-resolution image reconstruction apparatus based on a classified dictionary database. The apparatus can select, from a training image, a first local block and a corresponding second down-sampled local block, extract corresponding features and combine the features into a dictionary group, and perform classification and pre-training on multiple dictionary groups by using calculated values of an LBS and an SES as classification marks, so as to obtain a classified dictionary database of multiple dictionary groups with classification marks. During image reconstruction, local features of a local block on an image to be reconstructed are extracted, the LBS and SES classification of the local block is matched with the LBS and SES classification of each dictionary in the classified dictionary database, so that matched dictionaries can be rapidly obtained, and lastly, image reconstruction is performed on the image to be reconstructed by using the matched dictionaries. Accordingly, the efficiency of super-resolution reconstruction of an image can be improved while high-frequency information of the image is restored.

### CROSS-REFERENCE TO RELATED APPLICATIONS

This application is a National Stage Appl. filed under 35 USC 371 of International Patent Application No. PCT/CN2014/078614 with an international filing date of May 28, 2014, designating the United States, now pending. The contents of all of the aforementioned applications, including any intervening amendments thereto, are incorporated herein by reference.

### FIELD OF THE INVENTION

The invention relates to the technical field of super resolution image, and more particularly to a method and a device for reconstructing a super resolution image based on a classification dictionary database.

### BACKGROUND OF THE INVENTION

Super resolution is also called up-sampling or image magnification, which is a processing technique to recover a clear high resolution image from a low resolution image. The super resolution is one of the basic techniques in the field of image and video processing and has broad application prospect in many fields, such as medical image processing, image recognition, digital photograph processing, and high definition television.

The early super resolution technique is primarily based on the reconstruction method and the interpolation method. The interpolation based on kernel is a kind of classic super resolution method, for example, bilinear interpolation, spline curve interpolation, and curve interpolation. However, this kind of algorithms is adapted to produce continuous data by known discrete data, blur and tooth effects still occur in the figures after processed by these algorithms, and the high frequency details lost in the low resolution image are unable to be recovered. In recent years, a large quantity of super resolution algorithms based on edge was proposed for the purpose of improving the unnatural effect of the conventional interpolation algorithm as well as the visual quality of the edge. However, this kind of algorithms are focused on the edge improvement but still unable to recover the high frequency texture details. In order to tackle the problem of the blur texture, some dictionary study methods are subsequently developed, in which, a high resolution dictionary corresponding to the low resolution is trained to recover the lost details in the low resolution image. However, such methods require matching the local image blocks of the low resolution image with the dictionaries, respectively, which is time-consuming and inefficient in image reconstruction.

### SUMMARY OF THE INVENTION

In accordance with one embodiment of the invention, there is provided a method for reconstructing a super resolution image based on a classification dictionary database. The method comprises:
1) selecting a plurality of first local image blocks from a training image, and extracting a plurality of second local image blocks corresponding to the plurality of the first local image blocks from the training image after down-sampling, in which each of the second image blocks comprises at least four adjacent pixels of the training image;
2) extracting local features of each of the first local image blocks to form a first dictionary, extracting local features of each of the second local image blocks corresponding to each of the first local image blocks to form a second dictionary, and mapping the first dictionary onto the second dictionary to form a dictionary group;
3) calculating a local binary structure and a sharp edge structure of each of the second local image blocks, using calculating results as classification markers of the dictionary group corresponding to each of the second local image blocks;
4) pre-training a plurality of the dictionary groups to yield a classification dictionary database, in which each of the dictionary groups of the classification dictionary database carries with corresponding classification makers;
5) calculating the local binary structure and the sharp edge structure of a third local image block on an image to be reconstructed to yield the classification markers of the third local image block, in which the third local image block comprises at least four adjacent pixels of the image to be reconstructed;
6) comparing the classification markers of the third local image block of the image to be reconstructed with the classification markers of each of the dictionary groups of the classification dictionary database, and extracting the dictionary group that has the same classification markers as the third local image block as a matching dictionary group of the third local image block; and
7) performing image reconstruction on the third local image block using the matching dictionary group to yield a reconstructed fourth local image block; and combining fourth local image blocks of the image to be reconstructed to yield a reconstructed image.

In accordance with another embodiment of the invention, there is provided a device for reconstructing a super resolution image based on a classification dictionary database. The device comprises:
a) a selecting unit, configured to select a plurality of first local image blocks from a training image and extract second local image blocks corresponding to the first local image blocks from the training image after down-sampling, in which each of the second image blocks comprises at least four adjacent pixels of the training image;
b) a first extracting unit, configured to extract local features of each of the first local image blocks selected by the selecting unit to form a first dictionary;
c) a second extracting unit, configured to extract local features of each of the second local image blocks selected by the selecting unit corresponding to each of the first local image blocks to form a second dictionary and to map the first dictionary onto the second dictionary to form a dictionary group;
d) a first calculating unit, configured to calculate a local binary structure and a sharp edge structure of each of the second local image blocks selected by the selecting unit as classification markers of the dictionary group corresponding to each of the second local image blocks;
e) a pre-training unit, configured to pre-train a plurality of the dictionary groups extracted by the first extracting unit and the second extracting unit to yield a classification dictionary database, in which each of the dictionary groups of the classification dictionary database carries with corresponding classification makers calculated by the first calculating unit;
f) a second calculating unit, configured to calculate the local binary structure and the sharp edge structure of a third local image block on an image to be reconstructed to yield the classification markers of the third local image block, in which the third local image block comprises at least four adjacent pixels of the image to be reconstructed;
g) a matching unit, configured to compare the classification markers of the third local image block of the image to be reconstructed acquired by the second calculating unit with the classification markers of each of the dictionary groups of the classification dictionary database acquired by the pre-training unit and to extract the dictionary group that has the same classification markers as the third local image block as a matching dictionary group of the third local image block; and
h) a reconstructing unit, configured to perform image reconstruction on the third local image block using the matching dictionary group acquired by the matching unit to yield a reconstructed fourth local image block and to combine all the fourth local image blocks of the image to be reconstructed to yield a reconstructed image.

In accordance with another embodiment of the invention, there is provided a system for reconstructing a super resolution image based on a classification dictionary database. The system comprises:
a) a data input unit, configured to input data;
b) a data output unit, configured to output data;
c) a storage unit, configured to store data comprising executable programs; and
d) a processor, being in data connection to the data input unit, a data output unit, a storage unit and configured to execute the executable programs

The executable programs comprise the above methods.

Advantages of the method for reconstructing the super resolution image based on the classification dictionary database according to embodiments of the invention are summarized as follows:

In the method and the device for reconstructing the super resolution image based on the classification dictionary database according to the embodiment of the invention, the first local image blocks and the corresponding second local image blocks after down-sampling are selected from the training image, corresponding features are extracted and combined to form the dictionary groups. Multiple dictionary groups are classified and pre-trained using the calculation results of the local binary structures and the sharp edge structures as the classification markers to obtain the classification dictionary database comprising multiple dictionary groups carried with classification markers. To reconstruct an image, the local features of the local image block of the image to be reconstructed are also extracted, and the classification of the local binary structures and the sharp edge structures of the third local image blocks are matched with the local binary structures and the sharp edge structures of each dictionary of the classification dictionary database so as to fast acquire the matching dictionary group. Finally, image reconstruction is performed on the image to be reconstructed using the matching dictionary group. Therefore, not only are the high frequency details of the image recovered, but also the reconstruction efficiency of the super resolution image is improved.

### BRIEF DESCRIPTION OF THE DRAWINGS

The invention is described hereinbelow with reference to the accompanying drawings, in which:

FIG. 1 is a flow chart illustrating a method for reconstructing a super resolution image based on a classification dictionary database in accordance with Example 1;

FIGS. 2A-2C are structure diagrams of classification of local image blocks in accordance with one embodiment of the invention;

FIG. 3 is a structure diagram of a device for reconstructing a super resolution image based on a classification dictionary database in accordance with Example 2; and

FIG. 4 is a structure diagram of a system for reconstructing a super resolution image based on a classification dictionary database in accordance with Example 3.

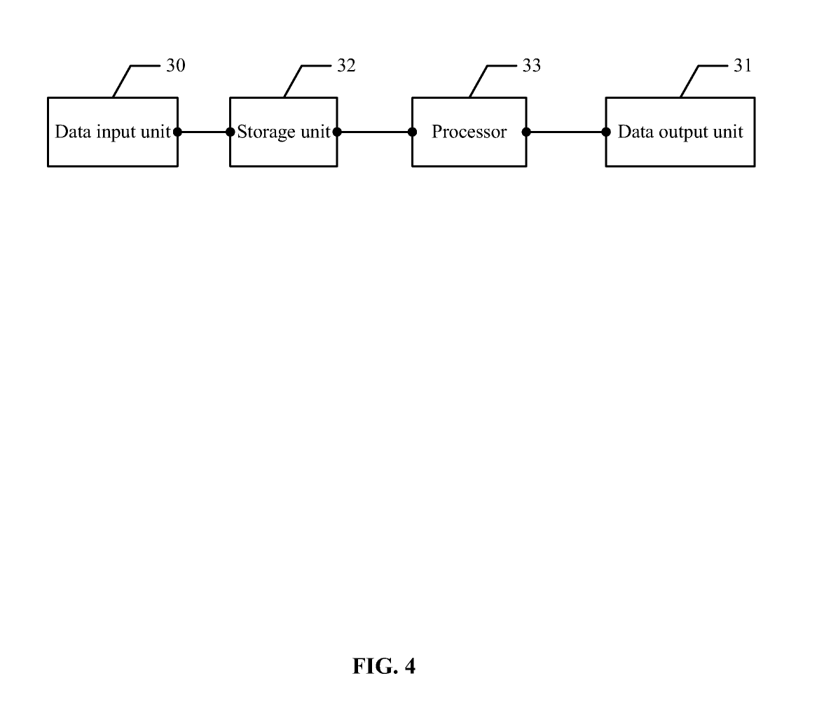

### DETAILED DESCRIPTION OF THE EMBODIMENTS

### Example 1

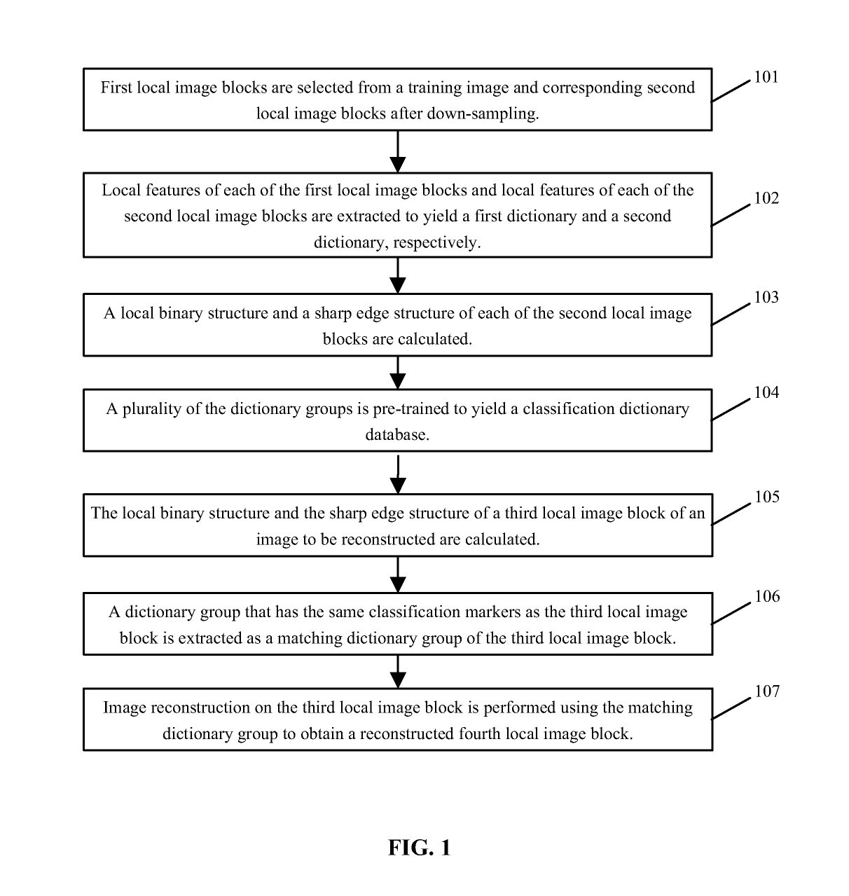

According to one embodiment of the invention, a method for reconstructing a super resolution image based on a classification dictionary database is provided. As shown in FIG. 1, the method comprises the following steps:

101. First local image blocks are selected from a training image and corresponding second local image blocks after down-sampling.

It should be noted that persons skilled in the art should understand that an image set can be pre-prepared for subsequently training a classification dictionary database. The image set optionally includes a plurality of training images. In selecting the training image, the image of high resolution should be selected. The image of high resolution refers to the image having clear high frequency details.

This step specifically comprises: selecting a plurality of the first local image blocks from the training image set including a plurality of training images, and selecting second image blocks corresponding to the first local image blocks from the training images after down-sampling.

Selection of each of the local image blocks is as follows: a first local image block having a size of 3×3 is randomly selected from one training image. Several different first local image blocks are selected from one training image or from several different training images, which is not specifically limited in the embodiment of the invention.

The first local image block is selected from the clear high resolution image. As being processed by down-sampling, the second local image blocks are local image blocks selected from low resolution image corresponding to the high resolution image where the first local image blocks are selected.

102. Local features of each of the first local image blocks and local features of each of the second local image blocks are extracted to yield a first dictionary and a second dictionary, respectively.

It should be noted that the extraction of the local features of each of the first local image block and extraction of the local features of each of the second local image block can be executed at the same time or in an order, which is not specifically limited herein. The first dictionary and the corresponding second dictionary are mapped to form a dictionary group for subsequently reconstructing local image blocks of low resolution.

In a preferred embodiment, the first dictionary is specifically acquired as follows: subtraction is performed between a gray value of each of the pixels of each of the first local image block with a mean value of the gray values of each of the first local image block to obtain residual values of each of the first local image blocks. And the residual values are adopted as the first dictionary corresponding to each of the first local image block.

In a preferred embodiment, the second dictionary is specifically acquired as follows: a local gray difference value, a first gradient value, a second gradient value are calculated, and calculating results are adopted as the second dictionary corresponding to each of the second local image blocks.

103. A local binary structure and a sharp edge structure of each of the second local image blocks are calculated.

The local binary structure and the sharp edge structure of each of the second local image block are calculated, and calculating results are adopted as classification markers of the dictionary group corresponding to the second local image block.

The first dictionary and the second dictionary are mapped to form a dictionary group. The local binary structure and the sharp edge structure are utilized to classify the local features of the second local image blocks so as to separate the dictionary group samples into different classes.

104. A plurality of the dictionary groups is pre-trained to yield a classification dictionary database

Each dictionary group of the obtained classification dictionary database carries with corresponding classification markers.

In a preferred embodiment, a k-mean clustering algorithm is utilized to pre-train a plurality of the dictionary groups to obtain an incomplete dictionary database.

In a preferred embodiment, a sparse coding algorithm is utilized to pre-train a plurality of the dictionary groups to obtain an over-complete dictionary database.

105. The local binary structure and the sharp edge structure of a third local image block of an image to be reconstructed are calculated.

The local image block comprises at least four adjacent pixels of the image to be reconstructed. The image to be reconstructed is a low resolution image. In order to acquire a corresponding clear high resolution image, it is required to recover the high frequency details of the image to be reconstructed.

Calculating the local binary structure and the sharp edge structure of a third local image block on an image to be reconstructed to yield the classification markers of the third local image block.

106. A dictionary group that has the same classification markers as the third local image block is extracted as a matching dictionary group of the third local image block.

The classification markers of the third local image block of the image to be reconstructed are compared with the classification markers of each of the dictionary groups of the classification dictionary database, and the dictionary group that has the same classification markers as the third local image block is extracted as the matching dictionary group of the third local image block.

Step 106 is specifically conducted as follows: the third local image block of the image to be reconstructed is classified using the local binary structure and the sharp edge structure, and the dictionary group that has the same classification markers as the third local image block is selected as the matching dictionary group of the third local image block.

In order to recover the high frequency details of the image to be reconstructed, it is required to reconstruct the image to be reconstructed using the dictionary groups of the classification dictionary database acquired from pre-training. In this embodiment, because the local binary structure and the sharp edge structure of the second dictionary of each dictionary group are calculated, respectively, before training the dictionary database, the local binary structure and the sharp edge structure of the third local image block of the image to be reconstructed is utilized in the matching process to fast find the corresponding classification dictionary group. Thus, the efficiency of the image reconstruction is improved, and the high frequency of the image that has low resolution and is to be reconstructed can be recovered.

107. Image reconstruction on the third local image block is performed using the matching dictionary group to obtain a reconstructed fourth local image block

All the fourth local image blocks of the image to be reconstructed are combined to obtain the reconstructed image.

In the method for reconstructing the super resolution image based on the classification dictionary database according to the embodiment of the invention, the first local image blocks and the corresponding second local image blocks after down-sampling are selected from the training image, local features of each of the first local image blocks and each of the second local image blocks are extracted and combined to form a dictionary group. The local binary structures and the sharp edge structures of the second local image blocks are calculated and classified, and a plurality of dictionary groups with classification markers is pre-trained according to the classifications to obtain a classification dictionary database comprising multiple dictionary groups. To reconstruct an image, the local binary structures and the sharp edge structures of the third local image blocks are calculated in the same way so as to fast acquire the matching dictionary group; and finally, image reconstruction is performed on the image to be reconstructed using the matching dictionary group. Therefore, not only are the high frequency details of the image recovered, but also the reconstruction efficiency of the super resolution image is improved.

Calculation process of the local binary structure and the sharp edge structure and the principle of the classification dictionary described in Example 1 is specifically explained hereinbelow.

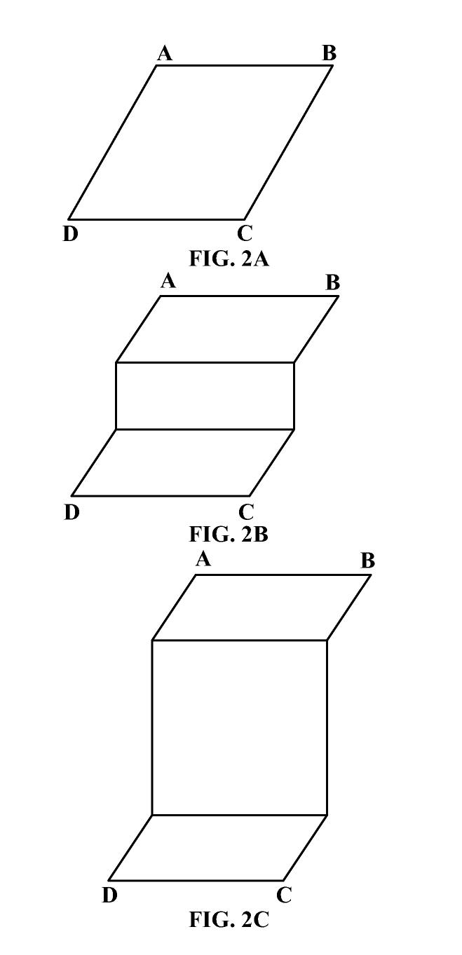

As shown in FIGS. 2A, 2B, and 2C, A, B, C, and D represent four locally adjacent pixels, and a height of each pixel reflects a gray value of each pixel. In FIG. 2A, the four pixels A, B, C, and D form a flat local region and have the same gray value. In FIG. 2B, the gray values of the pixels A and B are higher than the gray values of the pixels C and D. Herein LBS-Geometry (LBS_G) is defined in order to clarify the difference in the geometry structures, equation for calculating LBS-Geometry (LBS_G) is as follows:

$$LBS\_G = {\sum }_{p = 1}^{4} S ( {g}_{p} - {g}_{mean} ) {2}^{p - 1} , \\ S ( x ) = \{ \begin{matrix}1 , x \geq 0 \\ 0 , else\end{matrix} \qquad ( 1 )$$

in which, gₚ represents the gray value of a pth pixel in a local region, and gₘₑₐₙ represents a mean value of gray values of the local four pixels A, B, C, and D. In this example, the four pixels A, B, C, and D are taken as an example, while in other examples, the number of the pixels can be others, such as N, which represents a squared value of a positive integer.

Because the local image blocks, as shown in FIGS. 2B and 2C, have different degrees of the gray difference, the local image blocks still belong to different local modes. Thus, LBS-Difference (LBS_D) is defined in this example in order to represent the degree of local gray difference, and the following equation is obtained:

$$LBS\_D = {\sum }_{p = 1}^{4} S ( {d}_{p} - {d}_{global} ) {2}^{p - 1} , \\ {d}_{p} = \vert {g}_{p} - {g}_{mean} \vert \qquad ( 2 )$$

in which, d_{global} represents a mean value of all the local gray differences in an entire image.

The complete description of the LBS is formed combined with the LBS_G and the LBS_D, and the equation of the LBS is as follows:

$$LBS = {\sum }_{p = 1}^{4} S ( {g}_{p} - {g}_{mean} ) {2}^{p + 3} + {\sum }_{p = 1}^{4} S ( {d}_{p} - {d}_{global} ) {2}^{p - 1} \qquad ( 3 )$$

In the meanwhile, the SES is also defined in this example:

$$SES = {\sum }_{p = 1}^{4} S ( {d}_{p} - t ) {2}^{p - 1} \qquad ( 4 )$$

in which, t represents a preset gray threshold; and in one specific embodiment, t is preset to be a relatively large threshold for discriminating a sharp edge.

In this example, the training of the texture dictionary can be accomplished by a k-means clustering mode to yield an incomplete dictionary, or the training of the texture dictionary can be accomplished by a sparse coding mode to yield an over-complete dictionary.

When the k-means clustering mode is adopted to train the dictionary, a certain amount (for example, one hundred thousand) dictionary groups are selected. A plurality of class centers is clustered using the k-means clustering mode, and these class centers are used as classification dictionary database. The use of the k-means clustering mode for training the dictionary is able to establish the incomplete dictionaries with low dimensions.

The process for performing image reconstruction on each third local image block using the matching dictionary group in step 107 in Example 1 is illustrated hereinbelow:

Preferably, the fourth local image block x of high resolution after reconstruction of the corresponding third local image block y in the image to be reconstructed is obtained using the following formula:

x≈Dₕ(y)α (5)

in which, Dₕ(y) represents a first dictionary that has the same LBS and SES (the same classification markers) as y, and α represents an expression coefficient.

When using the over complete dictionary database to reconstruct the third local image block y, the coefficient α satisfies the sparsity, the second dictionary Dₗ(y) matching with y is used to calculate the sparse expression coefficient α, then the expression coefficient α is put into the equation (5) to calculate the corresponding forth local image block x. Thus, the acquisition of the optimized a can be transformed into the following optimization problem:

min∥α∥₀s.t.∥FD₁α−Fy∥₂²≦ε (6)

in which, ε represents a minimum value approaching 0, F represents an operation of selecting a feature descriptor, and in the classification dictionary provided in this example, the selected feature is a combination of a local gray difference, a first gradient value, and a second gradient value. Because a is sparse enough, L1 norm is adopted to substitute an L0 norm in the formula (6), then the optimization problem is converted to be the following:

$${min}_{α} {‖ {FD}_{1} α - Fy ‖}_{2}^{2} + λ {‖ α ‖}_{1} \qquad ( 7 )$$

in which, λ represents a coefficient regulating the sparsity and the similarity. The optimized sparse expression coefficient α can be acquired by solving the above Lasso problem, then the optimized sparse expression coefficient α is put into the equation (5) to calculate the high resolution fourth local image block x corresponding to y.

When using the incomplete dictionary database to reconstruct the third local image block y, α does not satisfy the sufficient sparsity, the K-nearest neighbor algorithm is used to find k Dₗ(y) dictionaries that are nearest to y, then linear combinations of k first dictionaries are adopted to reconstruct x.

When all the clear fourth local image blocks x of high resolution corresponding to each anamorphic third local image blocks y having low resolution in the image are reconstructed, the final clear image is restored.

### Example 2

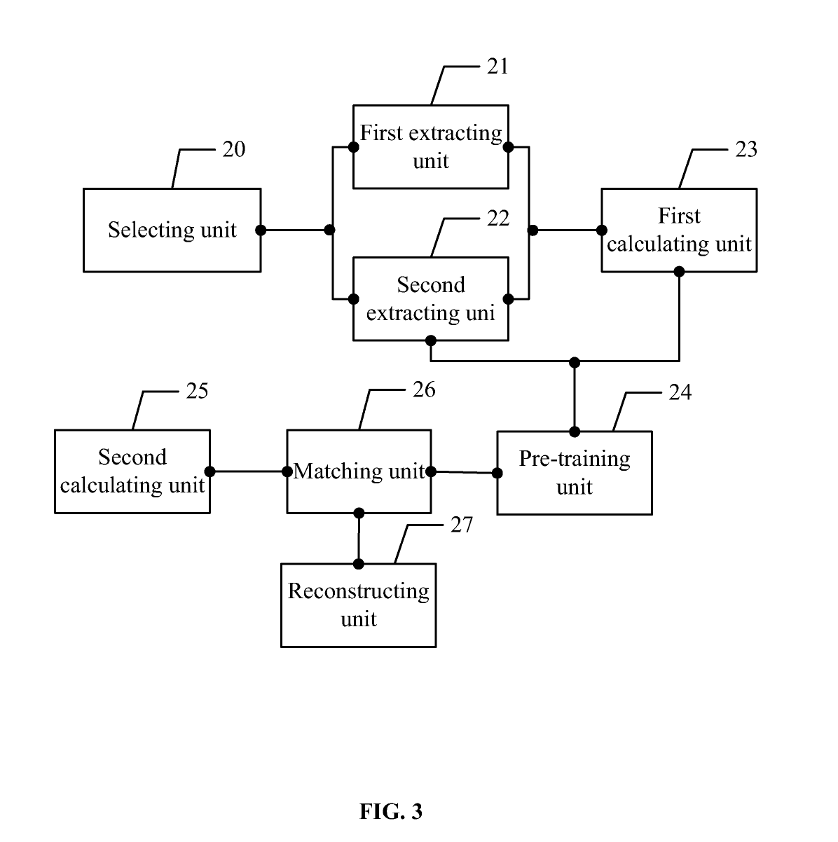

A device for reconstructing a super resolution image based on a classification dictionary database is provided in this example. As shown in FIG. 3, the device comprises:
a) a selecting unit 20, configured to select a plurality of first local image blocks from a training image and extract second local image blocks corresponding to the first local image blocks from the training image after down-sampling, in which each of the second image blocks comprises at least four adjacent pixels of the training image;
b) a first extracting unit 21, configured to extract local features of each of the first local image blocks selected by the selecting unit 20 to form a first dictionary;
c) a second extracting unit 22, configured to extract local features of each of the second local image blocks selected by the selecting unit 20 corresponding to each of the first local image blocks to form a second dictionary and to map the first dictionary onto the second dictionary to form a dictionary group;
d) a first calculating unit 23, configured to calculate a local binary structure and a sharp edge structure of each of the second local image blocks selected by the selecting unit 20 as classification markers of the dictionary group corresponding to each of the second local image blocks;
e) a pre-training unit 24, configured to pre-train a plurality of the dictionary groups extracted by the first extracting unit 21 and the second extracting unit 22 to yield a classification dictionary database, in which each of the dictionary groups of the classification dictionary database carries with corresponding classification makers calculated by the first calculating unit 23;
f) a second calculating unit 25, configured to calculate the local binary structure and the sharp edge structure of a third local image block on an image to be reconstructed to yield the classification markers of the third local image block, in which the third local image block comprises at least four adjacent pixels of the image to be reconstructed;
g) a matching unit 26, configured to compare the classification markers of the third local image block of the image to be reconstructed acquired by the second calculating unit 25 with the classification markers of each of the dictionary groups of the classification dictionary database acquired by the pre-training unit 24 and to extract the dictionary group that has the same classification markers as the third local image block as a matching dictionary group of the third local image block; and
h) a reconstructing unit 27, configured to perform image reconstruction on the third local image block using the matching dictionary group acquired by the matching unit to yield a reconstructed fourth local image block and to combine all the fourth local image blocks of the image to be reconstructed to yield a reconstructed image.

Preferably, the first extracting unit 21 is configured to perform subtraction between gray values of pixels of each of the first local image blocks and a mean value of gray values of each of the first local image blocks to obtain residual values of each of the first local image blocks as the first dictionary corresponding to each of the first local image blocks.

Preferably, the second extracting unit 22 is configured to calculate a local gray difference value, a first gradient value, and a second gradient value, and using calculating results as the second dictionary corresponding to each of the second local image blocks.

Preferably, the reconstructing unit 27 is configured to calculate the fourth local image block x after reconstruction of the third local image block using the following formula:

x≈Dₕ(y)α

in which, y represents the third local image block to be reconstructed, Dₕ(y) represents a first dictionary that has the same classification markers as the third local image block, and α represents an expression coefficient.

Preferably, the pre-training unit 24 is configured to pre-train the plurality of the dictionary groups using a sparse coding algorithm to yield an over-complete dictionary database.

Preferably, the pre-training unit 24 is configured to pre-train the plurality of the dictionary groups using a k-means clustering algorithm to yield an incomplete dictionary database.

In the device for reconstructing the super resolution image based on the classification dictionary database according to the embodiment of the invention, the first local image blocks and the corresponding second local image blocks after down-sampling are selected from the training image, corresponding features are extracted and combined to form the dictionary groups. Multiple dictionary groups are classified and pre-trained using the calculation results of the local binary structures and the sharp edge structures as the classification markers to obtain the classification dictionary database comprising multiple dictionary groups carried with classification markers. To reconstruct an image, the local features of the local image block of the image to be reconstructed are also extracted, and the classification of the local binary structures and the sharp edge structures of the third local image blocks are matched with the local binary structures and the sharp edge structures of each dictionary of the classification dictionary database so as to fast acquire the matching dictionary group. Finally, image reconstruction is performed on the image to be reconstructed using the matching dictionary group. Therefore, not only are the high frequency details of the image recovered, but also the reconstruction efficiency of the super resolution image is improved.

### Example 3

A system for reconstructing a super resolution image based on a classification dictionary database is provided in this example. The system comprises: a) a data input unit 30, configured to input data; b) a data output unit 31, configured to output data; c) a storage unit 32, configured to store data comprising executable programs; and d) a processor 33, being in data connection to the data input unit 30, a data output unit 31, a storage unit 32 and configured to execute the executable programs. The execution of the executable programs comprises all or partial of the steps of the methods as described in the above examples.

It can be understood by the skills in the technical field that all or partial steps in the methods of the above embodiments can be accomplished by controlling relative hardware by programs. These programs can be stored in readable storage media of a computer, and the storage media include: read-only memories, random access memories, magnetic disks, and optical disks.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for reconstructing a super resolution image based on a classification dictionary database, the method comprising:
1) selecting a plurality of first local image blocks from a training image, and extracting a plurality of second local image blocks corresponding to the plurality of the first local image blocks from the training image after down-sampling, wherein each of the second image blocks comprises at least four adjacent pixels of the training image;
2) extracting local features of each of the first local image blocks to form a first dictionary, extracting local features of each of the second local image blocks corresponding to each of the first local image blocks to form a second dictionary, and mapping the first dictionary onto the second dictionary to form a dictionary group;
3) calculating a local binary structure and a sharp edge structure of each of the second local image blocks, using calculating results as classification markers of the dictionary group corresponding to each of the second local image blocks;
4) pre-training a plurality of the dictionary groups to yield a classification dictionary database, wherein each of the dictionary groups of the classification dictionary database carries with corresponding classification makers;
5) calculating the local binary structure and the sharp edge structure of a third local image block on an image to be reconstructed to yield the classification markers of the third local image block, wherein the third local image block comprises at least four adjacent pixels of the image to be reconstructed;
6) comparing the classification markers of the third local image block of the image to be reconstructed with the classification markers of each of the dictionary groups of the classification dictionary database, and extracting the dictionary group that has the same classification markers as the third local image block as a matching dictionary group of the third local image block; and
7) performing image reconstruction on the third local image block using the matching dictionary group to yield a reconstructed fourth local image block; and combining fourth local image blocks of the image to be reconstructed to yield a reconstructed image.

2. The method of claim 1, wherein extracting the local features of each of the first local image blocks to form the first dictionary comprises: performing subtraction between gray values of pixels of each of the first local image blocks and a mean value of gray values of each of the first local image blocks to obtain residual values of each of the first local image blocks as the first dictionary corresponding to each of the first local image blocks.

3. The method of claim 1, extracting the local features of each of the second local image blocks corresponding to each of the first local image blocks to form the second dictionary comprises: calculating a local gray difference value, a first gradient value, and a second gradient value, and using calculating results as the second dictionary corresponding to each of the second local image blocks.

4. The method of any of claims 1-3, wherein performing image reconstruction on the third local image block using the matching dictionary group to yield a reconstructed fourth local image block comprises: calculating the fourth local image block x after reconstruction of the third local image block using the following formula:
x≈Dₕ(y)α
wherein, y represents the third local image block to be reconstructed, Dₕ(y) represents a first dictionary that has the same classification markers as the third local image block, and α represents an expression coefficient.

5. The method of claim 4, wherein pre-training the plurality of the dictionary groups to yield the classification dictionary database comprises: pre-training the plurality of the dictionary groups using a sparse coding algorithm to yield an over-complete dictionary database.

6. The method of claim 4, wherein pre-training the plurality of the dictionary groups to yield the classification dictionary database comprises: pre-training the plurality of the dictionary groups using a k-means clustering algorithm to yield an incomplete dictionary database.

7. The method of claim 5, wherein when using the over-complete dictionary to reconstruct the third local image block y, the expression coefficient α satisfies sparsity and is calculated according to the following formula:
min∥α∥₀s.t.∥FD₁α−Fy∥₂²≦ε
in which, Dₗ(y) represents the second dictionary that has the same classification markers as y, c represents a minimum value approaching 0, and F represents an operation of selecting a local feature.

8. The method of claim 6, wherein
when adopting the incomplete dictionary to reconstruct the third local image block y, the expression coefficient α does not satisfy the sparsity, and the reconstruction is performed as follows:
using a k-nearest neighbor algorithm to extract k second dictionaries Dl(y) that are nearest to y;
acquiring k corresponding first dictionaries Dh(y); and
adopting linear combination of the k first dictionaries Dh(y) to reconstruct the fourth local image block x, in which, k represents a number of selected dictionary samples that are preset, Dl(y) represents the second dictionary that has the same local binary structure and the sharp edge structure as y.

9. A device for reconstructing a super resolution image based on a classification dictionary database, the device comprising:
a) a selecting unit, configured to select a plurality of first local image blocks from a training image and extract second local image blocks corresponding to the first local image blocks from the training image after down-sampling, wherein each of the second image blocks comprises at least four adjacent pixels of the training image;
b) a first extracting unit, configured to extract local features of each of the first local image blocks selected by the selecting unit to form a first dictionary;
c) a second extracting unit, configured to extract local features of each of the second local image blocks selected by the selecting unit corresponding to each of the first local image blocks to form a second dictionary and to map the first dictionary onto the second dictionary to form a dictionary group;
d) a first calculating unit, configured to calculate a local binary structure and a sharp edge structure of each of the second local image blocks selected by the selecting unit as classification markers of the dictionary group corresponding to each of the second local image blocks;
e) a pre-training unit, configured to pre-train a plurality of the dictionary groups extracted by the first extracting unit and the second extracting unit to yield a classification dictionary database, wherein each of the dictionary groups of the classification dictionary database carries with corresponding classification makers calculated by the first calculating unit;
f) a second calculating unit, configured to calculate the local binary structure and the sharp edge structure of a third local image block on an image to be reconstructed to yield the classification markers of the third local image block, wherein the third local image block comprises at least four adjacent pixels of the image to be reconstructed;
g) a matching unit, configured to compare the classification markers of the third local image block of the image to be reconstructed acquired by the second calculating unit with the classification markers of each of the dictionary groups of the classification dictionary database acquired by the pre-training unit and to extract the dictionary group that has the same classification markers as the third local image block as a matching dictionary group of the third local image block; and
h) a reconstructing unit, configured to perform image reconstruction on the third local image block using the matching dictionary group acquired by the matching unit to yield a reconstructed fourth local image block and to combine all the fourth local image blocks of the image to be reconstructed to yield a reconstructed image.

10. The device of claim 9, wherein the first extracting unit is configured to perform subtraction between gray values of pixels of each of the first local image blocks and a mean value of gray values of each of the first local image blocks to obtain residual values of each of the first local image blocks as the first dictionary corresponding to each of the first local image blocks.

11. The device of claim 9, wherein the second extracting unit is configured to calculate a local gray difference value, a first gradient value, and a second gradient value, and using calculating results as the second dictionary corresponding to each of the second local image blocks.

12. The device of any of claims 9-11, wherein
the reconstructing unit is configured to calculate the fourth local image block x after reconstruction of the third local image block using the following formula:
x≈Dₕ(y)α
wherein, y represents the third local image block to be reconstructed, Dh(y) represents a first dictionary that has the same classification markers as the third local image block, and α represents an expression coefficient.

13. The device of claim 12, wherein the pre-training unit is configured to pre-train the plurality of the dictionary groups using a sparse coding algorithm to yield an over-complete dictionary database.

14. The device of claim 12, wherein the pre-training unit is configured to pre-train the plurality of the dictionary groups using a k-means clustering algorithm to yield an incomplete dictionary database.

15. A system for reconstructing a super resolution image based on a classification dictionary database, the system comprising:
a) a data input unit, configured to input data;
b) a data output unit, configured to output data;
c) a storage unit, configured to store data comprising executable programs; and
d) a processor, being in data connection to the data input unit, a data output unit, a storage unit and configured to execute the executable programs;
e) wherein the executable programs comprise the method of any of claims 1-8.
